(19) United States
(12) Patent Application Publication
(10) Pub. No.: US 2005/0123244 A1
(43) Pub. Date: Jun. 9, 2005

(54) Embedded optical waveguide coupler

(76) Inventors: Bruce A. Block, Portland, OR (US); Brandon Barnett, Beaverton, OR (US); Paul Davids, Portland, OR (US)

Correspondence Address: FISH & RICHARDSON, PC, 12390 EL CAMINO REAL, SAN DIEGO, CA, 92130-2081, US

(21) Appl. No.: 10/727,698

(22) Filed: Dec. 3, 2003

(51) Int. Cl. G02B 6/26; G02B 6/42

(52) U.S. Cl. 385/43; 385/15; 385/39; 385/42; 385/50; 385/129; 385/132

(57) ABSTRACT

Waveguide couplers to efficiently couple light from one waveguide to another with different cross sections, including but not limited to waveguides in compact integrated packages fabricated on substrates.

All rights in connection with this application are assigned to Intel Corporation.

This application relates to devices having optical waveguides, and more particularly, to integrated devices and circuits having optical waveguides fabricated on substrates such as semiconductor substrates.

Optical waveguides are optical devices for spatially confining and guiding optical signals. An optical waveguide may be formed, for example, by surrounding a high-index waveguide core with one or more low-index waveguide cladding regions, to guide the light along the waveguide core. For example, optical fiber is a waveguide with a cylindrical fiber core surrounded by cylindrical fiber cladding.

Optical waveguides may be used in a wide range of devices and applications. For example, an integrated optical or opto-electronic device may be constructed by integrating optical waveguides and other device components on a substrate.

### BRIEF DESCRIPTION OF THE DRAWINGS

FIGS. 1, 2A, 2B, and 2C are various views of one exemplary waveguide coupler according to one implementation.

FIG. 3 shows another view of the waveguide coupler shown in FIGS. 1, 2A, 2B, and 3C and illustrates the mode transformation.

FIG. 4 shows a waveguide coupler according to another implementation and corresponding mode transformation.

FIGS. 5A, 5B, 5C, 5D, and 5E show an exemplary fabrication flow for fabricating the waveguide couplers 100 and 400 in FIGS. 1 and 4.

FIG. 6 illustrates a photonic chip that implements waveguide couplers described in this application.

### DETAILED DESCRIPTION

Techniques and devices described in this application include waveguide couplers to efficiently couple light from one waveguide to another with different cross sections, including but not limited to waveguides in compact integrated packages fabricated on substrates. Such coupling between different waveguides may be generally used as an optical interface between optical devices having waveguides of different cross sections or as an optical focusing mechanism to change the cross section of light.

As a specific example, many photonic integrated circuits (ICs) use ridge or embedded channel waveguides on a substrate to guide light between different components integrated on the same substrate. Waveguides with different cross sections may be used in such a photonic IC and a waveguide coupler described in this application may be used to connect two different waveguides. Also, an on-chip waveguide at an input/output (I/O) port may have a cross section different from that of a waveguide external to the photonic IC that either supplies an optical input to the IC or receives an optical output from the IC. A waveguide coupler of this application, therefore, may be implemented as part of the I/O port of such a photonic IC to connect the external waveguide. In an application where a photonic IC may be coupled to an external fiber link, the cross section of the fiber core (e.g., around 8-9 microns) may be greater than the cross section of the on-chip waveguide core which may be a fraction of one micron in a high-index-contrast design such as a silicon core in a silicon oxide cladding. In addition, such a waveguide coupler may be implemented in an optical path on the chip to change the cross section of light and to allow for efficient optical coupling between different parts of an optical path, e.g., different optical elements or devices.

Waveguide couplers of this application generally use a transitional structure between two waveguides with a spatially varying cross section profile along the direction of optical propagation to gradually transform the mode of guided light from one waveguide to the other waveguide. This gradual transformation is “gradual” in the sense that the mode of the guided light adiabatically changes as it passes through the transitional structure. This requirement of adiabatic change reduces or minimizes the optical loss caused by the change of the guided mode. One way to meet this adiabatic requirement is that the transitional structure has an extended length so that the cross section changes gradually over this extended length.

The use of this extended length of the transitional structure, however, is undesirable in integrated photonic ICs because the extended length of the transitional structure becomes a barrier to miniaturizing the circuits. In photonic ICs, it is desirable that the length of this transitional structure be as small as possible to make the waveguide coupler compact and small because, like electronic IC counterparts, each component on photonic ICs should be minimized in order to integrate a large number of functionalities on a given real estate of a chip. Examples of waveguide couplers described in this application are specially structured to provide a strong lateral spatial confinement in the waveguide couplers and thus to reduce the length of transitional structure while still maintaining the optical adiabatic condition.

In one implementation, such an optical coupler may include a substrate to support a mesa, a first waveguide formed on the mesa and having one tapered end section which adiabatically transforms an optical mode guided in the first waveguide, and a second waveguide formed on the substrate and having a cross section larger than the first waveguide and a refractive index less than the first waveguide. The second waveguide has one waveguide section in which the first waveguide and said mesa are conformingly embedded to place the first waveguide near a center of the second waveguide.

In another implementation, an optical coupler may include a cladding layer having a mesa, a first waveguide core, and a second waveguide core. The index of the first waveguide core is greater than the cladding layer. The first waveguide core is formed on the mesa and has a tapered end section to adiabatically transform a mode of guided light. The second waveguide core has a cross section greater than a cross section of and an index less than an index of the first waveguide core. The second waveguide core is formed over the cladding layer and the first waveguide core to have a solid section and a hollow section. The hollow section has an opening to conformingly enclose the tapered end section and the mesa to surround the tapered end section by the mesa and the second waveguide core.

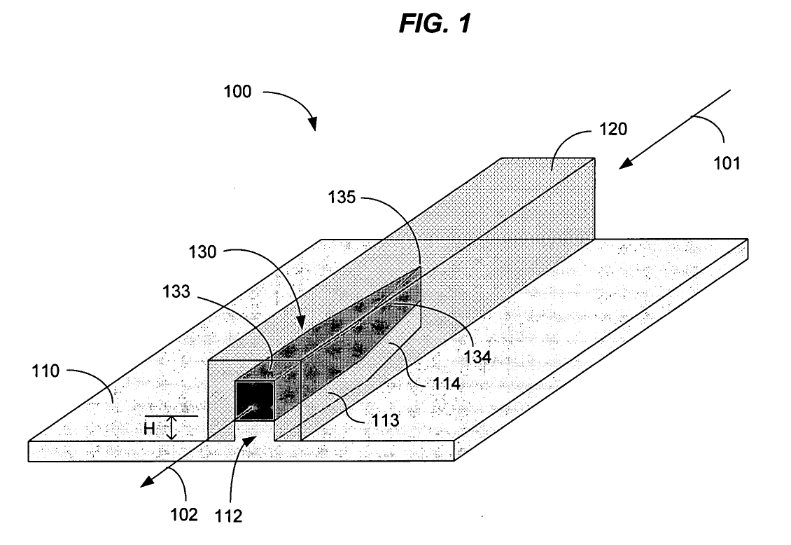

FIG. 1 shows an exemplary input waveguide coupler 100 integrated on a substrate 110 to interconnect a large waveguide 120 and a small waveguide 130. The substrate 110 may be a suitable semiconductor material such as Si, GaAs, and InP, or a non-semiconductor material such as quartz, glass, and polymer (e.g., polyimide, polycarbonate, and polymethyl methacrylate (PMMA)) materials. The large waveguide 120 has a solid section to receive and guide an input optical beam 101 and a hollow section in which at least a part of the small waveguide 130 is embedded. The large waveguide 120 is the waveguide core and its cladding is formed by air or a low-index dielectric medium above the substrate 110. The embedded portion of the small waveguide 130 are in contact with and conforms to contacted inner surfaces of the hollow section of the large waveguide 120. The refractive index of the large waveguide 120 is designed to be less than that of the small waveguide 130 so that the hollow section of the large waveguide 120 in effect becomes the waveguide cladding of a waveguide core formed by the embedded portion of the small waveguide 130. Both waveguides 120 and 130 may be singe-mode waveguides with different cross sections. The low index waveguide 120 may coexist with high index waveguide 130 as the cladding of the waveguide 130. Alternatively, the waveguide 120 may partially cover the waveguide 130 and terminate at a location where the light is transformed from the fundamental mode of the large waveguide 120 to the fundamental mode of the small waveguide 130.

The large waveguide 120 may be implemented with different materials, including fluorinated polyimide, acrylate, PMMA, PolySiloxane, silicon oxynitride, titanium oxide, glass and others. The refractive index of the large waveguide 120 may be typically set between about 1.4 and about 1.6. The small waveguide 130 has an index higher than that of the large waveguide 120. Exemplary materials for the small waveguide 130 include Si, amorphous Si, silicon nitride, titanium oxide, silicon carbide and others.

The substrate 110 is a dielectric material with a refractive index less than the index of the waveguide 130 and operates as a part of the cladding for the waveguides 130 and 120. The index of the substrate 110 is preferably less than that of the waveguide 120 and may be close or equal to the index of the waveguide 120. In some implementations, the substrate 110 may include a support substrate and a low index cladding layer on the top of the support substrate. In other implementations, the substrate 110 is used both as a support substrate and a low-index waveguide cladding layer. In one implementation, for example, the substrate 110 may include a silicon oxide cladding layer on a silicon substrate, the high-index waveguide 130 may be silicon, and the low-index waveguide 130 may be a polymer. The index contrast for the waveguide 130 may be higher than that for the waveguide 120.

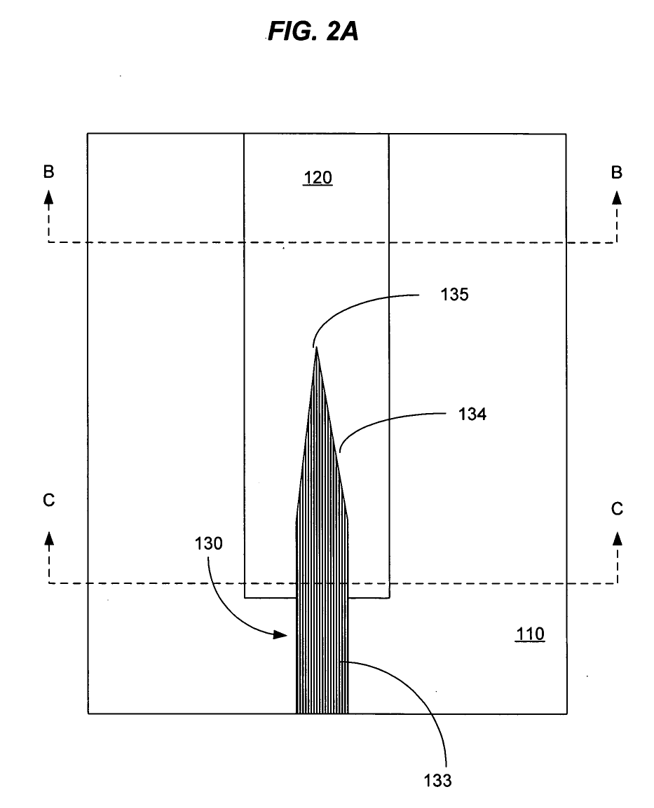

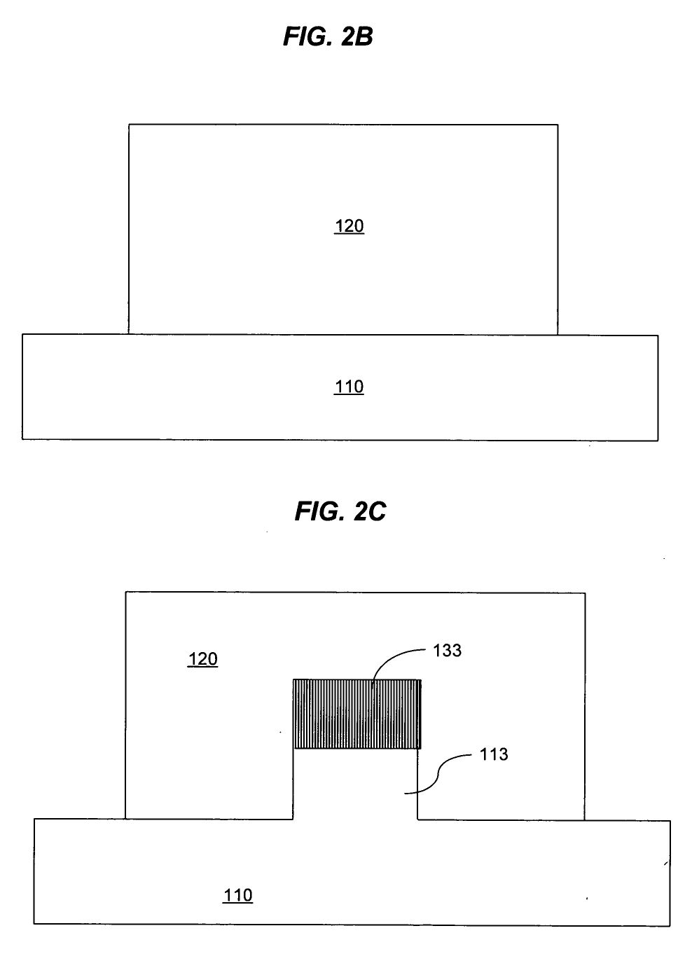

FIG. 2A is a top view of the waveguide coupler 100 to show additional structural details. As illustrated in FIGS. 1 and 2A, the embedded portion of the small waveguide 130 has a tapered section 134 with a tip 135 and a straight section 133. The tapered section 134 begins at the tip 135 and gradually increases its cross section. The end of the tapered section 134 conforms to the cross section of the straight section 133. This embedded portion of the waveguide is in contact with and conforms to the a part of the inner surfaces of the hollow section of the waveguide 120. Accordingly, the inner part of the hollow section of the large waveguide 120 includes a corresponding tapered hollow section conformingly in contact with the tapered section 134 and a straight hollow section conformingly in contact with the embedded straight section 133. FIGS. 2B and 2C show two cross sectional views taken along the lines BB and CC as marked in FIG. 2A, respectively, to show the solid section and the hollow section of the large waveguide 120.

Notably, FIGS. 1 and 2C show that the hollow section of the large waveguide 120 is deeper than the height of the small waveguide to include a low-index mesa 112 with a height, H, underneath the small waveguide 133 and protruded above the substrate 110. The shape of the mesa 112 conforms to the shape of the small waveguide 130 by having a straight mesa section 113 corresponding to the straight section 133 and a tapered mesa section 114 corresponding to the tapered section 134. Hence, the shape of the small waveguide 130 show in FIG. 2A is the shape of the mesa 112. The refractive index of the mesa 112 is designed to be less than that of the small waveguide 130 so that the mesa 112 forms a part of the waveguide cladding for the embedded portion of the small waveguide 130. The index of the small waveguide 130 is much higher than the indices of the large waveguide 120 and the mesa 112. Hence, this structure forms a high-index-contrast waveguide in the embedded section. In particular, the presence of the mesa 112 allows the embedded portion of the small waveguide 130 to deeply “bury” within the large waveguide 120. Hence, the high-index core formed by the embedded part of the small waveguide 130 is in close proximity to the center of the low index mode distribution. This structure strongly confines the guided light in the embedded small waveguide 130 and provides highly efficient coupling from large waveguide 120 to the small waveguide 130. Simulations based on the coupled mode equations verified this enhancement. This structure can achieve the desired optically adiabatic condition with a small length of the tapered section 134. In addition, this efficient coupling allows for reduction of the power requirements for the off-chip light source.

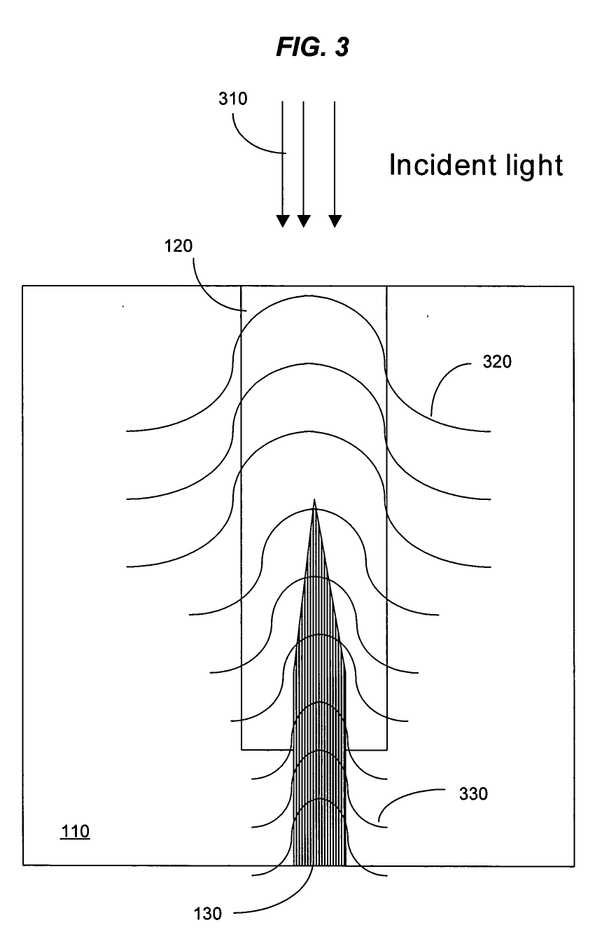

In operation, the above waveguide coupler 100 may operate to couple light from the large waveguide 120 to the small waveguide 130. Light is coupled between two waveguides 120 and 130 by both evanescent coupling and “butt coupling.” The relative amount of each type of coupling is controlled the amount of tapering and the shape of the tapering of the high index contrast waveguide 130. FIG. 3 shows that an input beam 310 is coupled into the large waveguide 320 with a low-index contrast in a fundamental mode 320. As the light encounters the tapered waveguide 130, the high-index contrast and the taper 134 cause the mode 320 to change and to shrink in the adiabatic manner without significant optical loss. At the straight section 133 of the high-index waveguide 130, the mode 320 is transformed into a fundamental mode 330 of the waveguide 130. Light in the mode 330 continues to propagate in the waveguide 130.

The coupler can certainly operate in an inverse direction to couple light from the waveguide 130 to the waveguide 120. In this mode of operation, the light initially guided by the waveguide 130 hits the tapered section 134 and the mode expands as the cross section of the tapered section 134 reduces along the direction of light propagation. At the end the tip 135 of the high index guide 130, the optical mode of the light is transformed and is substantially matched to the mode of the low index guide 120.

In the fundamental mode, the optical energy of the waveguide mode concentrates at the center of the waveguide. Hence, it is desirable to place the small waveguide 130 at or near the center of the large waveguide 120 to effectuate an efficient coupling between the modes of the waveguides 120 and 130. As the position of the waveguide 130 moves away from the center of the waveguide 130, the coupling efficiency decreases and a longer interaction length is needed to achieve a complete mode transform between the modes of the waveguides 120 and 130.

For example, consider a waveguide coupler where the large waveguide 120 has a 3-micron square cross section and is made of a polymer with a refractive index of 1.6 and the small waveguide 120 has a 0.3-micron square cross section and is made of Si with a refractive index of 3.5. Assume that both waveguides are single-mode waveguides. When the waveguide 130 is at the center of the large waveguide, the tapered section with a length of less than 20 microns is sufficient to completely transform the fundamental modes between the waveguides with a coupling loss less than 1 dB. In comparison, if the waveguide 130 is placed near the edge of the large waveguide 120, the tapered section with a length of more than 200 microns may be needed to completely transform the fundamental modes between the waveguides with a coupling loss less than 1 dB. Hence, the position of the waveguide 130 within the waveguide 120 may cause the length of the tapered region to change as much as 10 times in this particular example. Similar dependence of the optical coupling in mode transform and the position of the waveguide 130 in the waveguide 120 can be found in waveguides with other cross section profiles. Accordingly, the mesa structure 112 is designed to place the waveguide 130 near or at the center of the waveguide 120 to reduce the length of the tapered region for the adiabatic mode transformation.

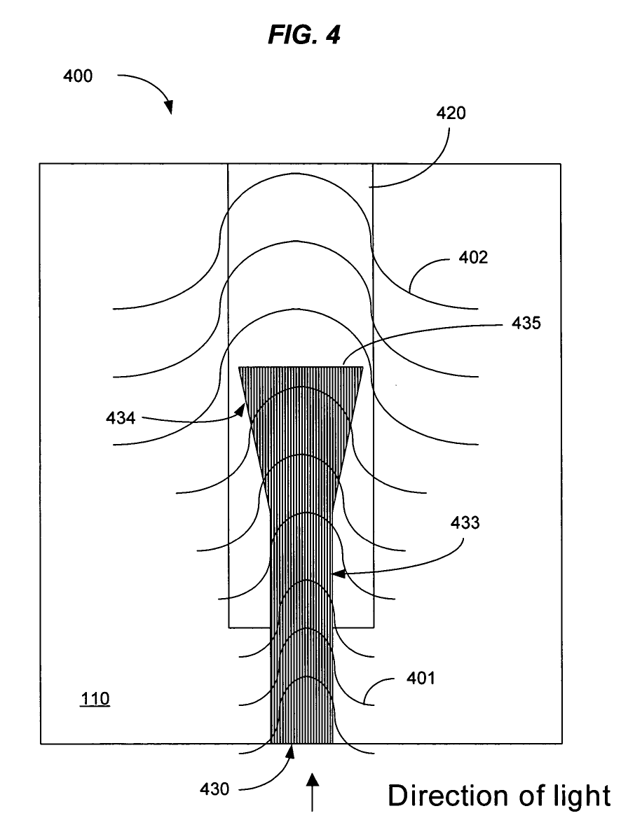

FIG. 4 shows another example of a waveguide coupler 400 of this application. Similar to the coupler 100, the coupler 400 provides coupling between a large low-index waveguide 420 and a small, high-index waveguide 430 with a tapered section 434 and a straight section 433 in an embedded configuration. Hence, the embedded portion of the waveguide 430 is raised above the substrate 110 to be at or near the center of the large waveguide 420 by a mesa. Different from the device 100, the tapered section 434 in the coupler 400 is designed to expand in its cross section from the end of the straight section 433 to a large end facet 435 that is close to the cross section of the large waveguide 430. Accordingly, the hollow section of the large waveguide 420 is shaped to conform to the embedded part of the waveguide 430 and the underlying mesa above substrate 110.

FIG. 4 further illustrates the mode transformation of light initially guided by the waveguide 430. Light is initially guided in the waveguide 430 in a mode 401. As the light in the mode 401 enters the tapered section 434 towards the waveguide 420, it begins to expand after entering the tapered section 434 adiabatically. At the end facet 435, the mode defined by the tapered section 434 substantially matches a mode 402 of the solid section of the waveguide 420. Hence, the light in the tapered section 430 is coupled into the mode 420 and continues to propagate in the waveguide 420. The reverse operation is possible to couple light initially guided in the waveguide 420 into the waveguide 430.

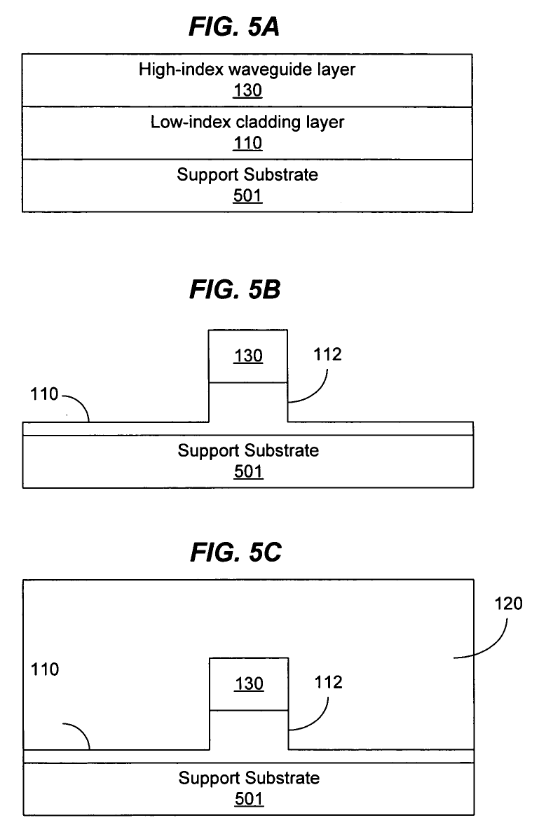

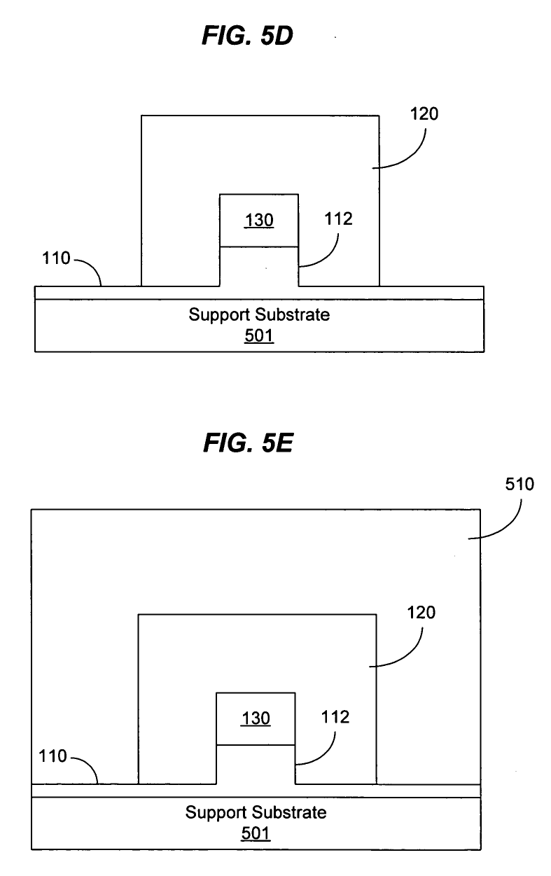

FIGS. 5A, 5B, 5C, 5D, and 5E show an exemplary fabrication flow for fabricating the waveguide couplers 100 and 400 in FIGS. 1 and 4. First, a substrate 510 such as a semiconductor, a glass, or other suitable material is provided. A low-index cladding layer 110 and a high-index waveguide layer 130 are sequentially deposited over the substrate 501 (FIG. 5A). FIG. 5B shows that the layers 110 and 130 are patterned to form the desired tapered shape shown in either FIG. 2A or FIG. 4 to form the small high-index waveguide 130. Notably, the layer 110 is patterned below its top surface in contact with the bottom of the layer 130 to form the mesa 112. Alternatively, the substrate 510 may be directly patterned to form the mesa 112 to operate as the low-index cladding layer without using the separately formed cladding layer 110. FIG. 5C shows that a layer of a low-index waveguide layer 120 is next deposited over the patterned layers 130 and 110. The low-index cladding layer 110 should have a refractive index less than indices of the layers 120 and 120. Next in FIG. 5D, the low-index waveguide layer 120 is patterned as a stripe to either completely cover the waveguide 130 or partially cover part of the waveguide 130 that is near the tapered region and expose the rest of the waveguide 130. Up completion of this step, the large low-index waveguide 120 is formed to have a solid section and a hollow section conformingly wrapping around the waveguide 130 and the mesa 112. Optionally, a low index cladding overlay 510 may be formed over the entire structure as the cladding material for the low-index waveguide 120.

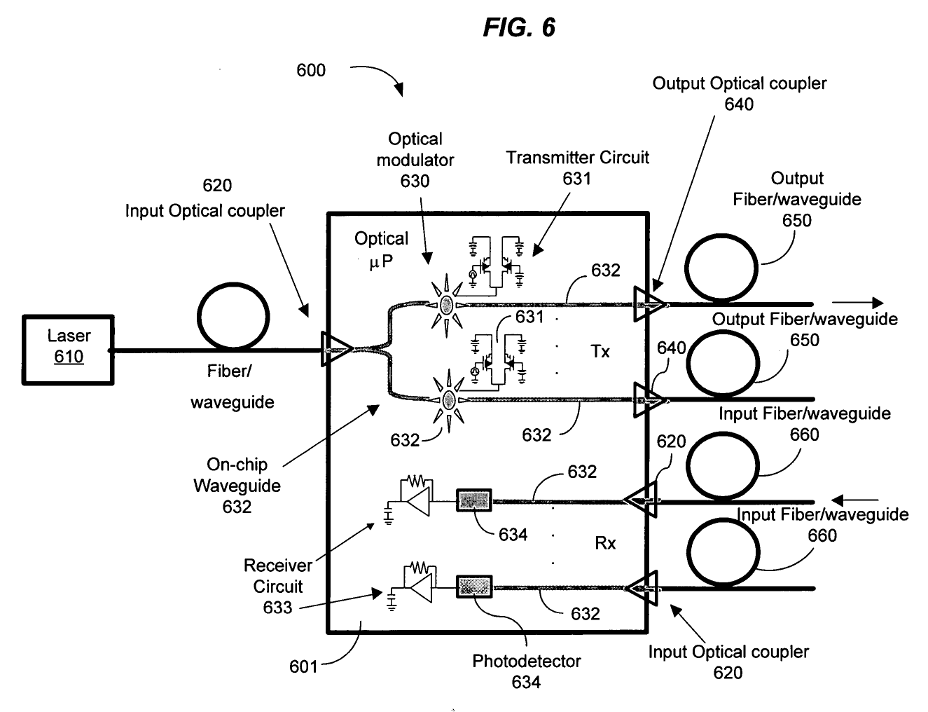

The waveguide couplers 100 and 400 in FIGS. 1 and 4 may be generally used to interconnect a low-index large waveguide and a high-index small waveguide. FIG. 6 shows a photonic chip where various photonic components, such as optical modulators, photodetectors, and transmitter circuits, are integrated on the same substrate. Fibers are used to send optical input signals into the chip and to transmit optical output signals of the chip off the chip. High-index waveguides such as Si waveguides integrated on the chip are used to direct on-chip optical signal. Waveguide optical couplers based on the designs in FIGS. 1 and 4 may be used as the input or output couplers to couple the fibers to the on-chip waveguides whose core cross sections are smaller than the fiber cores. For example, when the coupler 100 is used as an input coupler, an input fiber may be directly coupled to the large waveguide 120 for efficient coupling from the fiber to the large waveguide 120. The tapered section 134 then efficiently couples the light into the small on-chip waveguide 130 for further on-chip processing.

FIG. 6 illustrates one exemplary photonic chip 600 formed on a substrate 601. The chip 600 may include one or more input optical couplers 620 to receive various input optical signals and one or more output optical couplers 640 to output optical signals. Each input coupler 620 or output coupler 640 may be implemented by a waveguide coupler described in this application to provide coupling between an off-chip waveguide 612 or 660 (e.g., a fiber) and an on-chip waveguide 632 (e.g., a small Si waveguide). The chip 601 may include various photonic and electronic components or devices. As illustrated, optical modulators 630 and transmitter circuits 631 may be implemented to form an on-chip optical transmitter module (TX) to send out optical signals to off-chip waveguides 650. Optical detectors 634 and receiver circuits 633 may be implemented to form an on-chip receiver (RX) to receive optical signals from off-chip waveguides 660. A light source such as a laser 610 may be used to supply an input light beam via an off-chip waveguide 612 to supply optical power to the chip 600. Alternatively, a diode laser or LED may be integrated on the chip 600 to supply the light.

Only a few implementations are described. However, it is understood that variations and enhancements may be made.

1. A device, comprising:
a substrate to support a mesa;
a first waveguide formed on said mesa and having one tapered end section which adiabatically transforms an optical mode guided in said first waveguide; and
a second waveguide formed on said substrate and having a cross section larger than said first waveguide and a refractive index less than said first waveguide, said second waveguide having one waveguide section in which said first waveguide and said mesa are conformingly embedded to place said first waveguide near a center of said second waveguide.

2. The device as in claim 1, wherein said first waveguide comprises silicon.

3. The device as in claim 1, wherein said first waveguide comprises amorphous silicon.

4. The device as in claim 1, wherein said first waveguide comprises silicon nitride.

5. The device as in claim 1, wherein said first waveguide comprises silicon carbide.

6. The device as in claim 1, wherein said first waveguide comprises titanium oxide.

7. The device as in claim 1, wherein said second waveguide comprises a polymer material.

8. The device as in claim 1, wherein said second waveguide comprises fluorinated polyimide.

9. The device as in claim 1, wherein said second waveguide comprises acrylate.

10. The device as in claim 1, wherein said second waveguide comprises polymethyl methacrylate (PMMA).

11. The device as in claim 1, wherein said second waveguide comprises polysiloxane.

12. The device as in claim 1, wherein said second waveguide comprises silicon oxynitride.

13. The device as in claim 1, wherein said second waveguide comprises titanium oxide.

14. The device as in claim 1, wherein said second waveguide comprises a glass material.

15. The device as in claim 1, wherein said substrate comprises a semiconductor material.

16. The device as in claim 1, wherein said substrate comprises a polymer material.

17. The device as in claim 1, wherein said substrate comprises a glass material.

18. The device as in claim 1, wherein said substrate comprises quartz.

19. The device as in claim 1, wherein said tapered end section has a cross section that gradually increases in a direction towards a distal end of said tapered end section.

20. The device as in claim 1, wherein said tapered end section has a cross section that gradually decreases in a direction towards a distal end of said tapered end section.

21. The device as in claim 1, further comprising a cladding layer formed on said substrate, and wherein said mesa is formed in said cladding layer.

22. The device as in claim 21, wherein said substrate is made from silicon and said cladding layer comprises a silicon oxide material.

23. A device, comprising:
a cladding layer having a mesa;
a first waveguide core, whose index is greater than said cladding layer, formed on said mesa and having a tapered end section to adiabatically transform a mode of guided light; and
a second waveguide core with a cross section greater than a cross section of and an index less than an index of said first waveguide core, said second waveguide core formed over said cladding layer and said first waveguide core to have a solid section and a hollow section, said hollow section having an opening to conformingly enclose said tapered end section and said mesa to surround said tapered end section by said mesa and said second waveguide core.

24. The device as in claim 23, wherein said mesa has a height to position said first waveguide at or near a center of said hollow section of said second waveguide core.

25. The device as in claim 23, wherein said tapered section gradually increases a cross section in a direction from said hollow section to said solid section.

26. The device as in claim 23, wherein said tapered section gradually decreases a cross section in a direction from said hollow section to said solid section.

27. A device, comprising:
a first waveguide to guide an input light beam;
a substrate fabricated to comprise an input optical coupler to receive said input light beam and a second waveguide to receive light from said input optical coupler, said first waveguide coupled to said input optical coupler to direct light to said second waveguide,
wherein said input optical coupler comprises:
a cladding layer having a mesa, a first waveguide core, whose index is greater than said cladding layer, formed on said mesa and having a tapered end section to adiabatically transform a mode of guided light, said first waveguide core optically coupled to said first waveguide, and
a second waveguide core with a cross section greater than a cross section of and an index less than an index of said first waveguide core, said second waveguide core formed over said cladding layer and said first waveguide core to conformingly enclose said tapered end section near or at a center of said second waveguide core, said second waveguide core optically coupled to said second waveguide.

28. The device as in claim 27, further comprising an optical modulator on said substrate to receive and modulate at least a portion of said input light beam, and

29. The device as in claim 28, further comprising a circuit on said substrate coupled to control said optical modulator.

30. The device as in claim 28, further comprising an output optical coupler on said substrate to receive modulated light from said optical modulator and to direct modulated light off said substrate.
